(19) United States
(12) Patent Application Publication
(10) Pub. No.: US 2012/0068372 A1
(43) Pub. Date: Mar. 22, 2012

(54) NANOIMPRINT TEMPLATE AND PATTERN TRANSCRIPTION APPARATUS

(76) Inventors: Akiko Mimotogi, Yokohama-shi (JP); Ryoichi Inanami, Yokohama-shi (JP); Kentaro Kasa, Kawasaki-shi (JP); Masato Suzuki, Yokohama-shi (JP); Manabu Takakuwa, Yokohama-shi (JP); Yohko Furutono, Tokyo (JP); Yumi Nakajima, Tokyo (JP)

(21) Appl. No.: 13/233,426

(22) Filed: Sep. 15, 2011

(30) Foreign Application Priority Data
Sep. 16, 2010 (JP) 2010-208540

(51) Int. Cl. B28B 11/08; B29C 45/76

(52) U.S. Cl. 264/40.1; 425/445; 425/169

(57) ABSTRACT

According to one embodiment, a nanoimprint template using a pattern transcription to a substrate by a nanoimprint technique, the template includes a transcription pattern and an alignment mark on a main surface of a main body, wherein the alignment mark comprises a polarizer.

### CROSS-REFERENCE TO RELATED APPLICATIONS

This application is based upon and claims the benefit of priority from prior Japanese Patent Application No. 2010-208540, filed Sep. 16, 2010, the entire contents of which are incorporated herein by reference.

### FIELD

Embodiments described herein relate generally to a nanoimprint template and a pattern transcription apparatus.

### BACKGROUND

Recently, a nanoimprint technique has come into use for cost reduction in forming a pattern on a substrate. According to the nanoimprint technique, a template having a pattern is pressed to a resin applied onto a substrate to transcribe the pattern from the template to the resin on the substrate.

Here, during the pattern transcription, an alignment between the template and the substrate (e.g., a semiconductor wafer) needs to be executed, and alignment marks formed on the template and the substrate are used for the alignment. However, light refractive indexes of the template and the resin (e.g., a resist) are extremely close to each other. Therefore, the alignment mark of the template becomes invisible when filled with the resin during the pattern transcription. This makes it difficult to achieve a highly accurate alignment.

The following techniques have been suggested to solve the above-motioned problem.

According to one technique, a physical dam is provided on a template, thereby preventing a resin from entering an alignment mark during pattern transcription. However, the disadvantage of this technique is that adding the dam reduces usable area.

According to another technique, first and second surfaces having a step are provided in a template. A pattern is formed in the first surface, and an alignment mark is formed in the second surface. This prevents the alignment mark from being filled with a resin during pattern transcription. However, according to this technique, the surface for forming the pattern is different from the surface for forming the alignment mark, so that a highly accurate alignment is difficult. As the pattern and the alignment mark have to be independently formed during the manufacture of the template, there is also a problem of increased manufacturing costs.

### BRIEF DESCRIPTION OF THE DRAWINGS

FIG. 1 is a diagram showing a pattern transcription apparatus;

FIGS. 2A and 2B are diagrams, each showing a template;

FIG. 3 is a flowchart showing a pattern transcription method;

FIGS. 4 to 7 are diagrams showing a pattern transcription method;

FIGS. 8 to 10 are diagrams showing examples of a position measurement portion; and

FIG. 11 is a diagram showing a pattern transcription apparatus.

### DETAILED DESCRIPTION

In general, according to one embodiment, a nanoimprint template using a pattern transcription to a substrate by a nanoimprint technique, the template comprising: a transcription pattern and an alignment mark on a main surface of a main body, wherein the alignment mark comprises a polarizer.

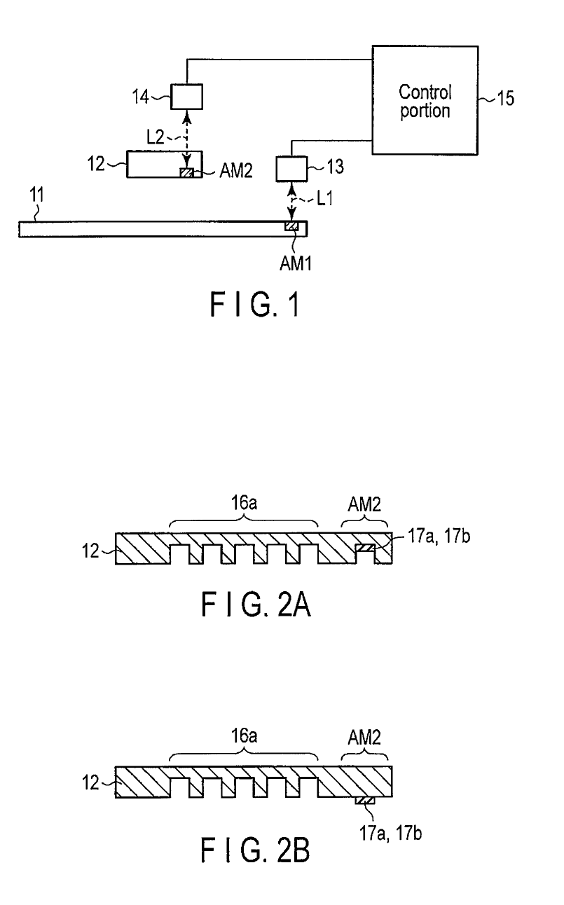

FIG. 1 shows a main part of a pattern transcription apparatus.

This pattern transcription apparatus is used for transcribing a pattern to a substrate by a nanoimprint technique (e.g., for nanoimprint photolithography).

Substrate (e.g., semiconductor substrate) 11 has alignment mark AM1, and nanoimprint template 12 has alignment mark AM2. Position measurement portion 13 detects alignment mark AM1 of substrate 11 by use of first light L1, and thereby measures a position of substrate 11. Position measurement portion 14 detects alignment mark AM2 of nanoimprint template 12 by use of second light L2, and thereby measures a position of nanoimprint template 12.

Control portion 15 controls relative positions of substrate 11 and nanoimprint template 12 on the basis of information from position measurement portions 13 and 14.

In this embodiment, position measurement portion 13 is provided to detect alignment mark AM1, and position measurement portion 14 is provided to detect alignment mark AM2. However, one of position measurement portions 13 and 14 can be used to simultaneously detect two alignment marks AM1 and AM2. In this case, one of position measurement portions 13 and 14 can be omitted.

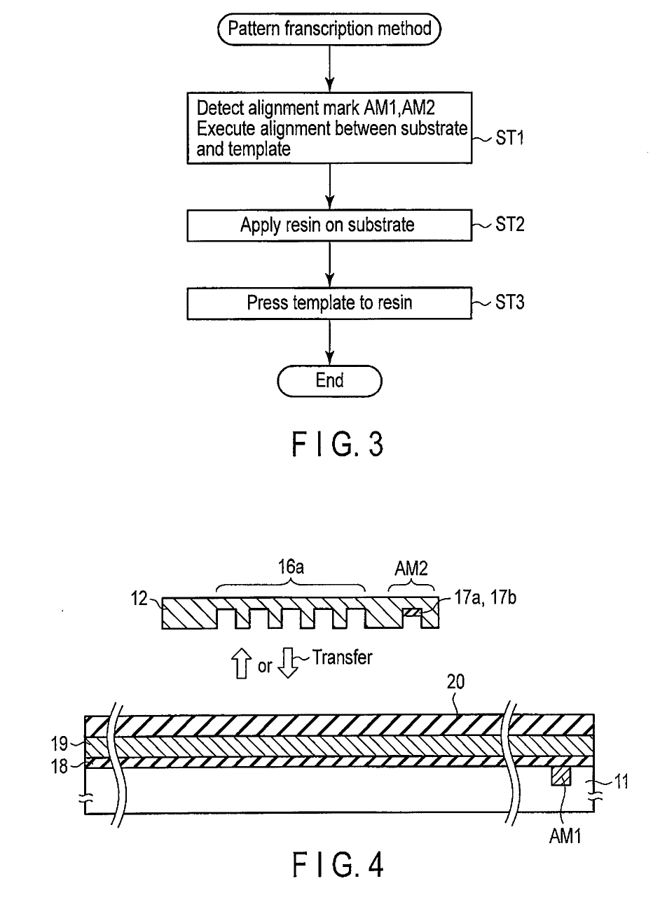

FIGS. 2A and 2B show nanoimprint templates.

The template in the example comprises transcription pattern 16 and alignment mark AM2 on a main surface of a main body. This is attributed to the fact that if the surface for forming alignment mark AM2 is different from the surface for forming transcription pattern 16a, highly accurate position control is impossible because of a step between these surfaces.

However, when transcription pattern 16a is filled with a resin during pattern transcription, alignment mark AM2 is also filled with the resin at the same time. The problem in this case is that alignment mark AM2 becomes invisible because light refractive indexes of the template and the resin (e.g., a resist) are extremely close to each other.

Therefore, in this embodiment, alignment mark AM2 comprises polarizer 17a or phase difference film 17b.

For example, when alignment mark AM2 comprises polarizer (e.g., polarization film) 17a, a polarizing direction of an irradiated light to alignment mark AM2 is adjusted such that alignment mark AM2 can be detected even if alignment mark AM2 is filled with the resin.

When alignment mark AM2 comprises phase difference film 17b, a phase difference of a reflected light from alignment mark AM2 is detected such that alignment mark AM2 can be detected even if alignment mark AM2 is filled with the resin.

As shown in FIG. 2A, polarizer 17a or phase difference film 17b may be formed in a concave portion of template 12 and combined with a conventional alignment mark. Alternatively, as shown in FIG. 2B, alignment mark AM2 may only comprise polarizer 17a or phase difference film 17b.

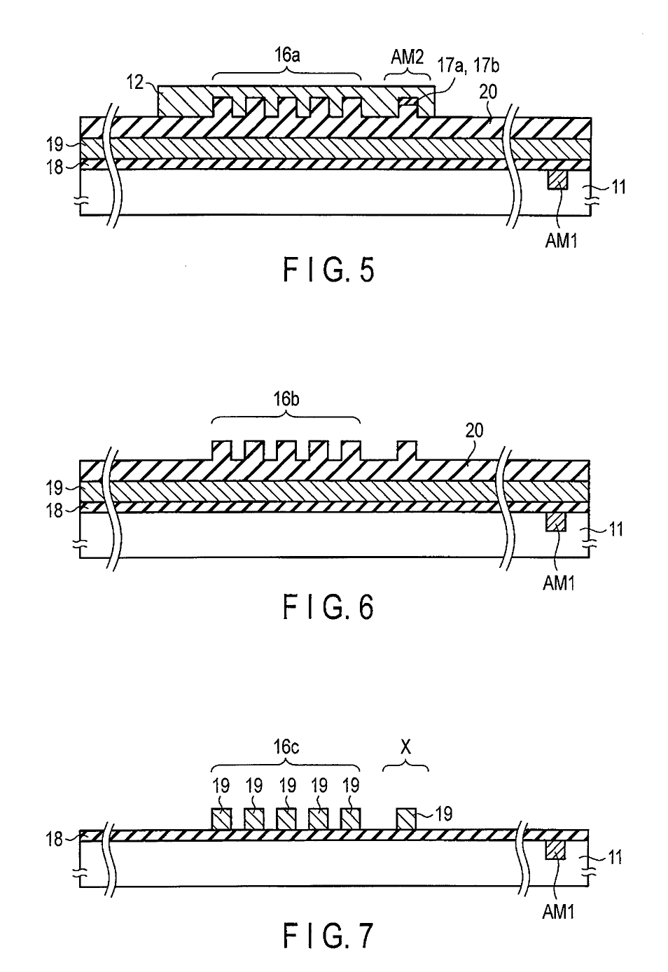

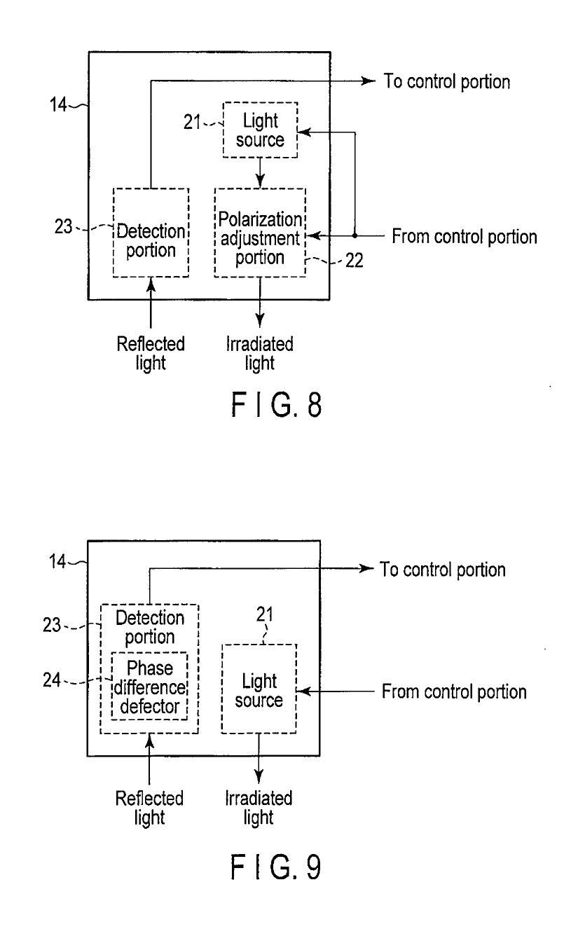

FIG. 3 shows a pattern transcription method using the pattern transcription apparatus in FIG. 1 and the template in FIGS. 2A and 2B. FIG. 4 to FIG. 7 show one step of the pattern transcription method in FIG. 3.

In the example described in this embodiment, insulating layer 18, conductive layer 19, and resist layer 20 are formed on substrate 11, and a pattern of template 12 is transcribed to resist layer 20.

First, alignment mark AM1 of substrate 11 and alignment mark AM2 of template 12 are detected, and alignment between substrate 11 and template 12 is executed. Further, a resin is applied onto substrate 11 to form resist layer 20 (steps ST1 to ST2).

This situation is shown in FIG. 4.

Furthermore, template 12 is pressed to the resin (resist layer 20) so that the positional relation between substrate 11 and template 12 is maintained (step ST3).

Here, when template 12 is pressed to resist layer 20, substrate 11 alone may be transferred, or template 12 alone may be transferred, or both of them may be transferred.

When template 12 is being pressed to resist layer 20, alignment mark AM2 is filled with the resin (resist layer 20), as shown in FIG. 5. However, alignment mark AM2 can be detected owing to polarizer 17a or phase difference film 17b, so that control portion 15 in FIG. 1 can keep track of the positional relation between substrate 11 and template 12 even in this situation.

Therefore, if the positional relation does not fulfill a predetermined relation, the positional relation can be finely corrected to fulfill the predetermined relation even after template 12 is pressed to resist layer 20.

After resist layer 20 is solidified, template 12 is removed from resist layer 20, thereby transcribing pattern 16b of the template to resist layer 20, as shown in FIG. 6. Further, resist layer 20 is used as a mask to etch conductive layer 19, thereby forming pattern 16c of conductive layer 19, as shown in FIG. 7.

Here, when the alignment mark comprises concavities and convexities in the surface of the template, and polarizer 17a or phase difference film 17b (e.g., the case shown in FIG. 2A), the alignment mark of the template is transcribed to conductive layer 19, and new alignment mark X is formed, as shown in FIG. 7.

This alignment mark X can be used for an alignment between the substrate and the template when a new pattern is formed on a layer higher than conductive layer 19.

By the way, in FIG. 3, steps ST1 and ST2 are replaceable each other.

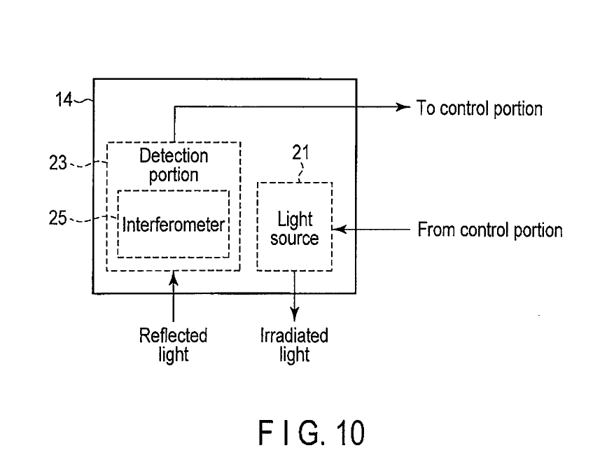

FIG. 8 to FIG. 10 show examples of position measurement portion 14 of the pattern transcription apparatus in FIG. 1.

FIG. 8 shows a configuration example of position measurement portion 14 when the alignment mark of the template comprises the polarizer. In this example, position measurement portion 14 comprises light source 21 which generates an irradiated light to the alignment mark, polarization adjustment portion 22 which adjusts a polarizing direction of the irradiated light, and detection portion 23 which detects a reflected light from the alignment mark.

In this case, a combination of a polarizing direction of the polarizer and a polarizing direction of the polarization adjustment portion is changed under the control of control portion 15 in FIG. 1. As a result, even if the alignment mark of the template is filled with the resin, a contrast between the alignment mark and parts therearound can be observed.

This enables a highly accurate alignment without any disadvantage.

FIG. 9 shows a configuration example of position measurement portion 14 when the alignment mark of the template comprises the phase difference film. In this example, position measurement portion 14 comprises light source 21 which generates an irradiated light to the alignment mark, and detection portion 23 having phase difference director 24 which detects a phase difference of a reflected light from the alignment mark.

In this case, the phase difference of the reflected light is detected under the control of control portion 15 in FIG. 1. As a result, even if the alignment mark of the template is filled with the resin, a contrast between the alignment mark and parts therearound can be observed.

This enables a highly accurate alignment without any disadvantage.

FIG. 10 shows a configuration example of position measurement portion 14 when the alignment mark of the template only comprises concavities and convexities (when a conventional alignment mark is used). In this example, position measurement portion 14 comprises light source 21 which generates an irradiated light to the alignment mark, and detection portion 23 having interferometer 25 which detects a change of a refractive index of a reflected light from the alignment mark.

In this case, under the control of control portion 15 in FIG. 1, a normal alignment using an imaging device (e.g., a CCD or a CMOS image sensor) is executed before the alignment mark of the template is filled with the resin, and interferometer 25 is used to detect a change of a refractive index of a reflected light after the alignment mark of the template is filled with the resin.

Interferometer (e.g., a differential interferometer) 25 can detect a slight change of refractive indexes of the alignment mark and the resin, and can therefore observe an interface therebetween.

This enables a highly accurate alignment without any disadvantage.

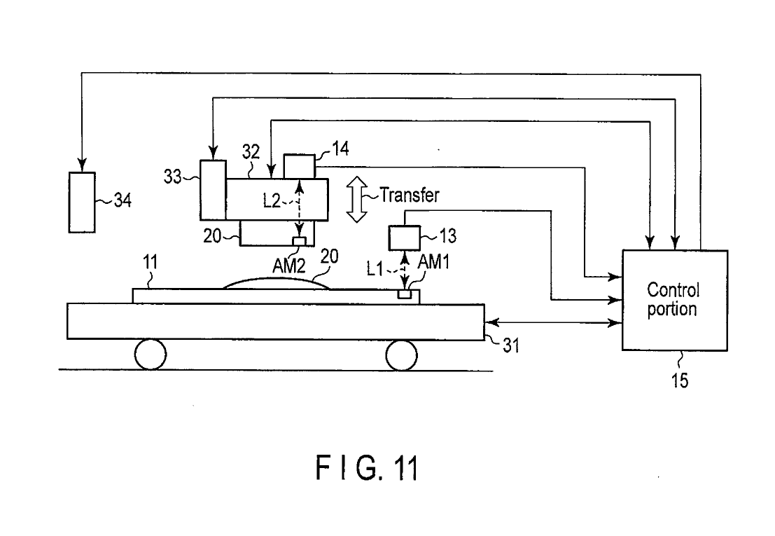

FIG. 11 shows a pattern transcription apparatus as an application example.

The pattern transcription apparatus comprises position measurement portions 13 and 14, substrate holder 31, template holder 32, alignment measurement portion 33, resin applying portion 34, and control portion 15. Although not shown here, the pattern transcription apparatus may comprise an ultraviolet light source for solidifying a resin.

Substrate holder 31 holds substrate 11 having alignment mark AM1 by, for example, a vacuum chuck. Substrate holder 31 comprises a mechanism for transferring substrate 11 in a horizontal direction (x-y direction). Substrate holder 31 may comprise a mechanism for transferring substrate 11 in a vertical direction (z direction).

Template holder 32 holds nanoimprint template 12 by, for example, a vacuum chuck. Template holder 32 comprises a mechanism for transferring template 12 in the vertical direction (z direction). Template 12 has a transcription pattern and alignment mark AM2 in its surface that faces substrate 11.

Alignment measurement portion 33 measures a position of a predetermined mark pattern formed on substrate 11. The measurement result is transferred to control portion 15.

Resin applying portion 34 has a function of applying resist 20 onto substrate 11.

Position measurement portion 13 detects alignment mark AM1 of substrate 11 by use of first light L1, and thereby measures a position of substrate 11. Position measurement portion 14 detects alignment mark AM2 of nanoimprint template 12 by use of second light L2, and thereby measures a position of nanoimprint template 12. As has been described, one of position measurement portions 13 and 14 can be omitted.

Control portion 15 controls the operations of position measurement portions 13 and 14, substrate holder 31, template holder 32, alignment measurement portion 33, and resin applying portion 34.

The use of such a pattern transcription apparatus enables a highly accurate alignment without any disadvantage during pattern transcription.

According to the embodiment, it is possible to provide a nanoimprint template and a pattern transcription apparatus that enable a highly accurate alignment without any disadvantage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A nanoimprint template using a pattern transcription to a substrate by a nanoimprint technique, the template comprising:
a transcription pattern and an alignment mark on a main surface of a main body, wherein the alignment mark comprises a polarizer.

2. The template of claim 1,
wherein the polarizer is provided on a bottom surface of a concave portion.

3. The template of claim 1,
wherein the polarizer is provided on the main surface.

4. A pattern transcription method using the template of claim 1, the method comprising:
detecting the alignment mark of the template and an alignment mark of the substrate;
executing an alignment between the substrate and the template;
applying a resin on the substrate; and
pressing the template to the resin.

5. A pattern transcription apparatus comprising:
a position measurement portion measuring a position of the template of claim 1; and
a position control portion controlling the position of the template,
wherein the position measurement portion comprises a polarization adjustment portion adjusting a polarizing direction of an irradiated light to the alignment mark of the template.

6. A nanoimprint template using a pattern transcription to a substrate by a nanoimprint technique, the template comprising:
a transcription pattern and an alignment mark on a main surface of a main body, wherein the alignment mark comprises a phase difference film.

7. The template of claim 6,
wherein the polarizer is provided on a bottom surface of a concave portion.

8. The template of claim 6,
wherein the polarizer is provided on the main surface.

9. A pattern transcription method using the template of claim 6, the method comprising:
detecting the alignment mark of the template and an alignment mark of the substrate;
executing an alignment between the substrate and the template;
applying a resin on the substrate; and
pressing the template to the resin.

10. A pattern transcription apparatus comprising:
a position measurement portion measuring a position of the template of claim 6; and
a position control portion controlling the position of the template,
wherein the position measurement portion comprises a phase difference detector detecting a phase difference of a reflected light from the alignment mark of the template.

11. A pattern transcription apparatus executing a pattern transcription from a nanoimprint template to a substrate by a nanoimprint technique, the apparatus comprising:
a position measurement portion measuring a position of the template; and
a position control portion controlling the position of the template,
wherein the position measurement portion comprises an interferometer detecting a change of a refractive index of a reflected light from the alignment mark of the template.
